(19) United States
(12) Patent Application Publication
(10) Pub. No.: US 2008/0110710 A1
(43) Pub. Date: May 15, 2008

(54) Chassis Suspension for a Motor Vehicle

(76) Inventor: Reinhold Berberich, Frankfurt (DE)

Correspondence Address: COHEN, PONTANI, LIEBERMAN & PAVANE, 551 FIFTH AVENUE, SUITE 1210, NEW YORK, NY, 10176, US

(21) Appl. No.: 11/667,881

(22) PCT Filed: Oct. 5, 2005
(86) PCT No.: PCT/EP05/54996

§ 371 Date: Oct. 25, 2007

(30) Foreign Application Priority Data
Nov. 15, 2004 (DE) 10 2004 055 050.6

(51) Int. Cl. F16F 9/46

(52) U.S. Cl. 188/266.2

(57) ABSTRACT

A chassis suspension for a motor vehicle comprises an electrically driven chassis suspension component having a contact unit which is detachably linked with a mating contact unit disposed on a control cable. The mating contact unit is provided with an acceleration sensor having a connection cable.

The invention relates to a chassis suspension for a motor vehicle, with an electrically driven chassis suspension component which has a contact unit which can be detachably connected to a mating contact unit arranged on a control cable.

In the case of chassis suspension components of this type, such as, for example, vibration dampers with variable damping force, a contact connection can take place by means of a mating contact unit which can be detachably connected to the contact unit.

If an acceleration sensor is also to be assigned to the vibration damper, the damper has to be modified for it by a holding device or a flange being provided in order to fasten the acceleration transmitter. At the same time, in addition to the connection cable for the chassis suspension component, a further cable for the acceleration sensor is also required.

It is therefore the object of the invention to provide a chassis suspension of the type mentioned at the beginning with measurement of acceleration, the chassis suspension having a simple contact-making construction which has only a few separate components.

This object is achieved according to the invention in that the mating contact unit has one or more acceleration sensors which have connection cables.

In this case, the acceleration sensors can also be multi-axial acceleration sensors.

By means of this design, mating contact unit and acceleration sensor form a single component with a single housing, thus considerably reducing both the outlay on installation and the storage of the component.

Depending on requirements, it is also easily possible to use a mating contact unit with or without an acceleration sensor in identical chassis suspension components.

The sensor configuration is determined just by the mating contact unit used with or without an acceleration sensor.

The use of mating contact units with an acceleration sensor makes it possible for chassis suspension components which already exist to be provided with additional functionality.

Fault-prone plug-in contacts for acceleration sensors arranged separately are unnecessary.

Furthermore, the entire unit of the mating contact unit forms a mechanical protection against damage of the acceleration sensor during transportation or the process of installation of the mating contact unit.

Chassis suspension components can be, for example, magnetorheological dampers or active displacement elements, such as plungers (hydraulic cylinder between spring and wheel).

It is particularly advantageous if the chassis suspension component is a vibration damper device with variable damping force, which has a cylinder and a piston dividing the interior of the cylinder, which is filled with a damping fluid, into a first fluid chamber and a second fluid chamber, with a fluid connection connecting the fluid chambers to each other, with a piston rod which is connected to the piston and is brought out of the cylinder in a sealed manner through the first fluid chamber, and with a valve unit, which is fastened to the cylinder or the piston rod, for setting the passage cross section of the fluid connection, the valve unit having an electric actuating drive and the contact unit.

This makes it possible, even when only some of the vibration damper devices of the motor vehicle are to be provided with acceleration sensors, for all the vibration damper devices to be of identical design and for only the mating contact units to be of differing design.

Depending on requirements, the mating contact units can be arranged on the wheel part in order to detect acceleration forces thereof or on the body part in order to detect the acceleration forces on the body.

It is possible either for the acceleration sensor to be integrated into the mating contact unit or into an adapter via which the mating contact unit can be detachably connected to the contact unit.

For further integration and simplification of installation, the connection cable can form a cable unit with the control cable.

A rapid contact connection is possible by contact unit and mating contact unit forming a plug-in contact.

The contact unit can be connected to the chassis suspension component via a cable, with the contact unit being able to be fastened detachably to the chassis suspension component preferably at a holder of the cylinder.

Exemplary embodiments of the invention are illustrated in the drawing and will be described in more detail below. In the drawing:

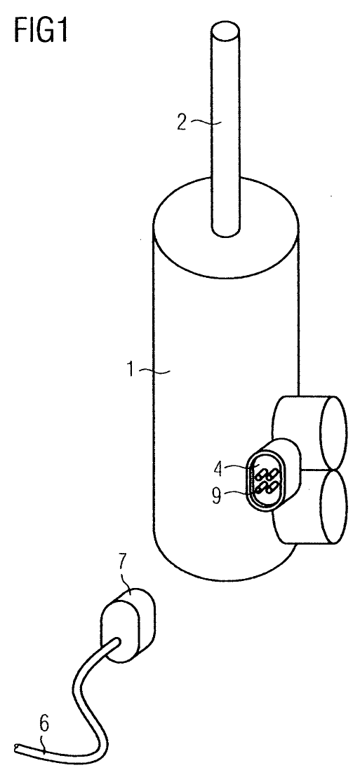

FIG. 1 shows a perspective view of a first exemplary embodiment of a vibration damper device

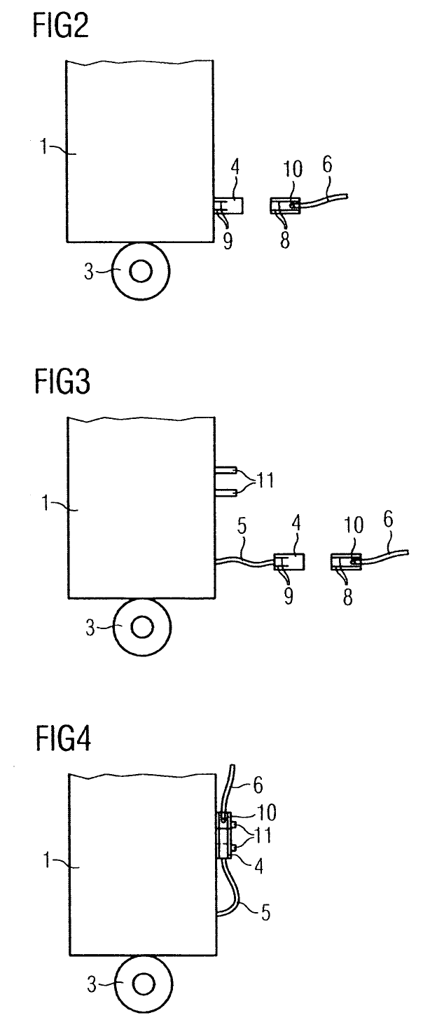

FIG. 2 shows a schematic illustration of the vibration damper device according to FIG. 1

FIG. 3 shows a schematic illustration of a second exemplary embodiment of a vibration damper device with detached mating contact unit

FIG. 4 shows a schematic illustration of the vibration damper device according to FIG. 3 with contact made with the mating contact device.

The vibration damper devices illustrated for a motor vehicle have a cylinder 1, the interior of which is divided by a piston (not illustrated) from which a piston rod 2 is guided to the outside in a sealed manner.

A joint eye (not illustrated) is arranged at the free end of the piston rod 2 and a joint eye 3 is likewise arranged at that end of the cylinder 1 which is opposite the piston rod 2.

A contact unit 4 with contact pins 9 is arranged on the cylinder 1 in a direct and fixed manner in FIGS. 1 and 2 and via a cable 5 in FIGS. 3 and 4.

A mating contact unit with contact bushes 8 is arranged on a cable unit 6, which leads to the motor vehicle body (not illustrated), said contact bushes forming with the contact unit 4 a plug-in contact which can be plugged together. Furthermore, an acceleration sensor 10 is arranged in the mating contact unit 7.

The control cable of the mating contact unit 7 and the connection cable of the acceleration sensor 10 are combined together to form the cable unit 6.

In the exemplary embodiment of FIGS. 3 and 4, clips 11 are arranged on the cylinder 1, in which clips, when contact unit 4 and mating contact unit 7 are plugged one inside the other, this entire unit can be fastened by clipping to the cylinder 1 (FIG. 4).

1.-8. (canceled)

9. A chassis suspension for a motor vehicle, comprising:
an electrically driven chassis suspension component with a first contact unit; and
a mating contact unit detachably connectable to the first contact unit, the mating unit being arranged on a control cable, and the mating control unit comprising an accelerator sensor having a connection cable.

10. The chassis suspension of claim 9, wherein the chassis suspension component is a vibration damper device with variable damping force and includes a cylinder having an interior filled with damping fluid, a piston dividing the interior of the cylinder into a first fluid chamber and a second fluid chamber, a fluid connection connecting the first and second fluid chambers, a piston rod connected to the piston and sealingly extending out of the cylinder through the first fluid chamber, and a valve unit fastened to one of the cylinder or the piston rod configured to set a cross section of the fluid connection, the valve unit having an electric actuating drive connected to the contact unit.

11. The chassis suspension of claim 9, the acceleration sensor is integrated into the mating contact unit.

12. The chassis suspension of claim 9, the acceleration sensor is integrated into an adapter via which the mating contact unit can be detachably connected to the contact unit.

13. The chassis suspension of claim 9, wherein the connection cable forms a cable unit with the control cable.

14. The chassis suspension of claim 9, wherein the first contact unit and mating contact unit form a plug-in contact.

15. The chassis suspension of claim 9, further comprising a cable connecting the contact unit to the chassis suspension component, the contact unit being detachably mountable on the chassis suspension component.

16. The chassis suspension of claim 15, further comprising a holder arranged on the cylinder, wherein the contact unit is detachably mountable to the holder.

17. The chassis suspension of claim 10, the acceleration sensor is integrated into the mating contact unit.

18. The chassis suspension of claim 10, the acceleration sensor is integrated into an adapter via which the mating contact unit can be detachably connected to the contact unit.

19. The chassis suspension of claim 10, wherein the connection cable forms a cable unit with the control cable.

20. The chassis suspension of claim 10, wherein the first contact unit and mating contact unit form a plug-in contact.

21. The chassis suspension of claim 10, further comprising a cable connecting the contact unit to the chassis suspension component, the contact unit being detachably mountable on the chassis suspension component.

22. The chassis suspension of claim 21, further comprising a holder arranged on the cylinder, wherein the contact unit is detachably mountable to the holder.
